(19) United States
(12) Patent Application Publication
(10) Pub. No.: US 2007/0009131 A1
(43) Pub. Date: Jan. 11, 2007

(54) Portable audio system

(76) Inventor: Ricky Kuan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/313,820

(22) Filed: Dec. 22, 2005

(30) Foreign Application Priority Data
Jul. 5, 2005 (TW) 94211371

(51) Int. Cl. H04R 5/02; H04R 1/02

(52) U.S. Cl. 381/334; 381/300

(57) ABSTRACT

The present invention integrates an amplifier with a speaker into the portable audio system. Due to the design of the structure, a portable electronic device can be installed on the portable audio system. The portable audio system includes a body, at least one amplifier unit, at least one input/output interface unit and a circuit integration unit. The circuit integration unit includes an interface control unit, an amplifying circuit unit and an equalizing circuit unit. The amplifier can be rotated to any angle to provide multi-channel and surround sound effects. Furthermore, the portable audio system has a heat sink installed therein to lower the portable audio system's temperature.

### BACKGROUND OF THE INVENTION

1. Field of the Invention

The present invention relates to a portable audio system. In particular, this invention integrates an amplifier with speaker into a portable audio system. The portable electronic device can be installed on the portable audio system and connects with the portable audio system.

2. Description of the Related Art

Audio systems have developed from tape players, to CD players and are now adapting to MP3 technology and MP3 players. Due to the development of electronic compression and data storage technology, a user can play audio via portable electronic devices (such as laptops and multi-function PDAs etc.).

Please refer to FIG. 1. The laptop 10 has an embedded audio system 11 for playing audio tracks that are stored on the laptop 10. However, the embedded audio system 11 only provides a basic playing function and its amplifier cannot output high quality audio sounds.

In order to enlarge the number of playing functions and consumers' demands for better sound quality, external audio system 12 can be connected to the laptop (or desktop PC), as shown in FIG. 2. The user sets the external audio system 12 to replace the amplifier and controls the playing functions via the laptop 10. Using the above method, a user's desire for higher quality sound is satisfied. However, the user has to carry both the laptop 10 and the external audio system 12 with them at the same times. This is inconvenient for the user. Although the conventional method shown in the FIG. 2 can satisfy the user's requirement for better sound quality, there are still some issues (such as the inconvenience of carrying the two objects and the difficulties of integrating the two electronic apparatuses).

### SUMMARY OF THE INVENTION

In one particular aspect of the present invention solves the problems of low quality sound and difficult integration with the electronic apparatus. The present invention provides a portable audio system that integrates an amplifier, an equalizer and speakers. Due to the design of the portable audio system's structure, a portable electronic device can be installed on the portable audio system. In other words the portable audio system and the portable electronic device can be integrated into a single unit.

The portable audio system includes a body, at least one amplifier unit, at least one input/output interface unit and a circuit integration unit. A portable electronic device can be installed on the body. The amplifier unit connects with the body. The input/output interface unit is located on a side surface of the body. The circuit integration unit is located inside the body. The circuit integration unit includes an interface control unit, an amplifying circuit unit and an equalizing circuit unit. The interface control unit electrically connects with the input/output interface unit for controlling the signal from the input/output interface unit. The amplifying circuit unit electrically connects with the interface control unit and the amplifier unit for amplifying the audio signal. The equalizing circuit unit electrically connects with the amplifying circuit unit for improving the frequency response of the audio signal. The circuit integration unit is a circuit board; the interface control unit is a USB controller; the input/output interface unit is a USB interface.

The amplifier unit includes a first amplifier and a second amplifier that are located on a side surface of the body, and a third amplifier that is located on the bottom of the body. The first amplifier and the second amplifier individually connect with the body via a rotor. In this way the first amplifier and the second amplifier can be rotated to any angle. Due to the design of the body's structure, when the portable electronic device is installed on the body, it does not influence the rotation of the first amplifier and the second amplifier. The first amplifier and the second amplifier are media amplifiers. The third amplifier is a bass amplifier. The sound hoods of the first amplifier, the second amplifier and/or the third amplifier can be anti-magnetic sound hoods.

In order to provide more functions, the portable audio system further includes other units. For example, for representing sound with lights, a plurality of lighting units are electrically connected with the circuit integration unit and installed on a side surface of the body; for reducing the temperature, a heat sink module with a fan is installed in the inner of the body; for tuning the magnitude of sounds or audio effects, an audio effect tuning device is electrically connected with the circuit integration unit and installed on a side surface of the body.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic view of the embedded audio system of the prior art;

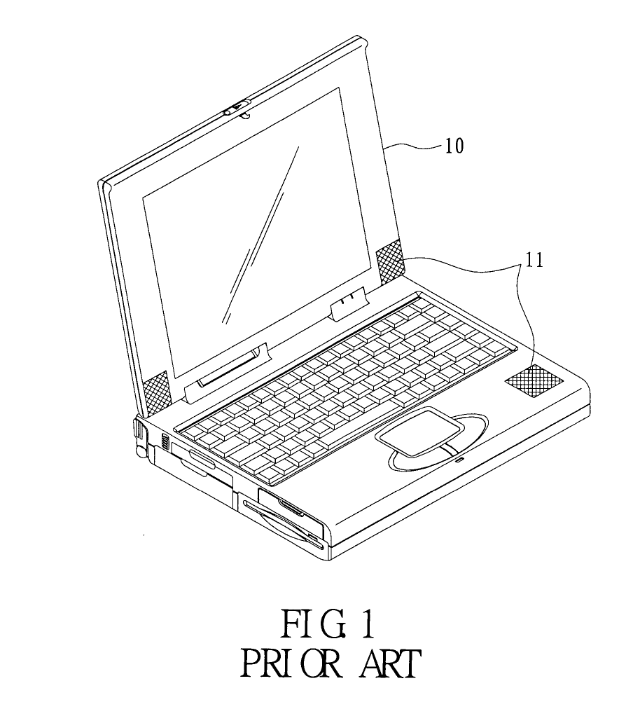

FIG. 2 is a schematic view of the external audio system of the prior art;

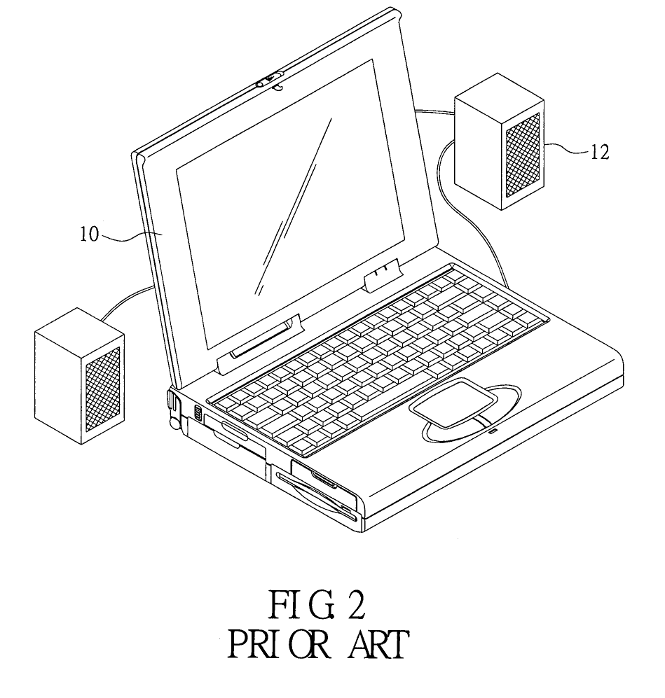

FIG. 3 is a first schematic view of the portable audio system of the present invention;

FIG. 4 is a second schematic view of the portable audio system of the present invention;

FIG. 5 is a third schematic view of the portable audio system of the present invention;

FIG. 6 is an exploded perspective view of the portable audio system of the present invention;

FIG. 7 is a schematic view of the amplifier of the portable audio system of the present invention;

FIG. 8 is a block diagram of the circuit integration unit of the portable audio system of the present invention;

FIG. 9 is a circuit diagram of the equalizing circuit unit of the portable audio system of the present invention; and

FIG. 10 is a circuit diagram of the amplifying circuit unit of the portable audio system of the present invention.

### DETAILED DESCRIPTION OF THE PREFERRED EMBODIMENTS

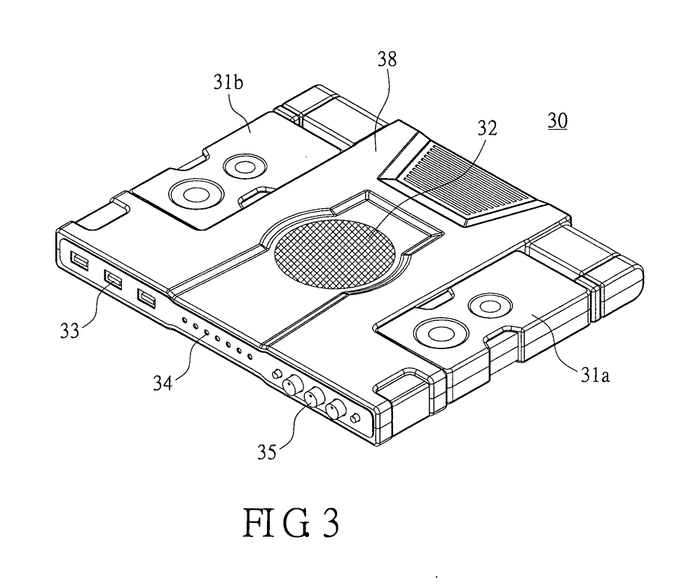

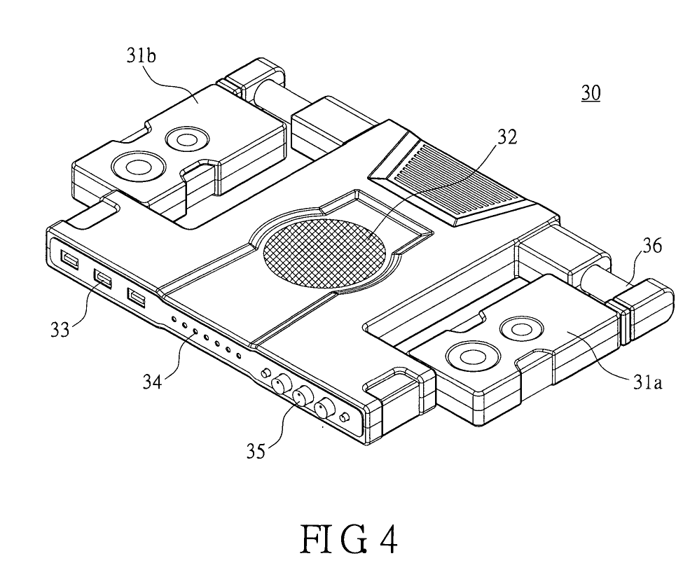

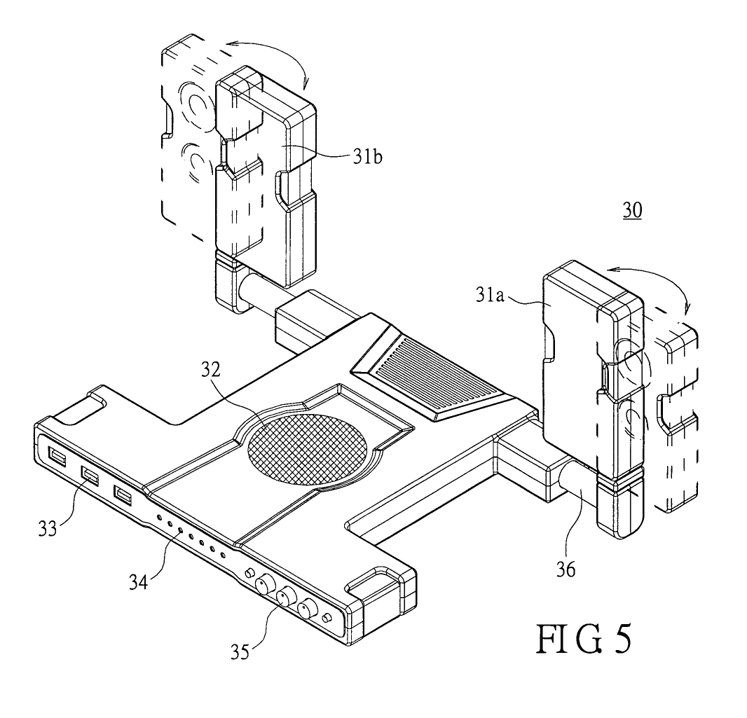

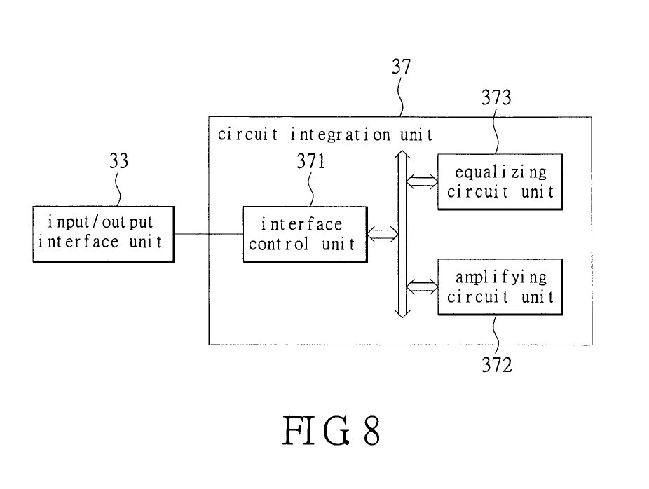

Please refer to FIGS. 3, 4, 5 and 8. The portable audio system 30 includes a body 38, a first amplifier 31a, a second amplifier 31b, an input/output interface unit 33 and a circuit integration unit 37. Due to the design of the body's structure 38, a portable electronic device (i.e. a laptop) can be installed on the body 38 of the portable audio system 30. So, the portable audio system 30 connects with the laptop into a single unit.

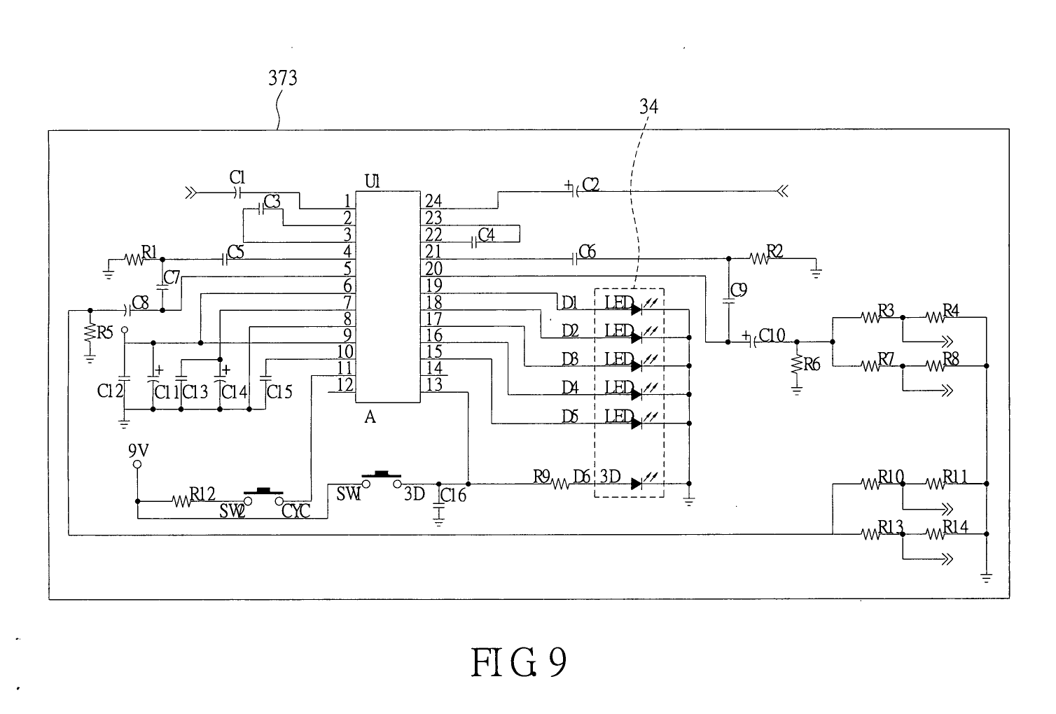

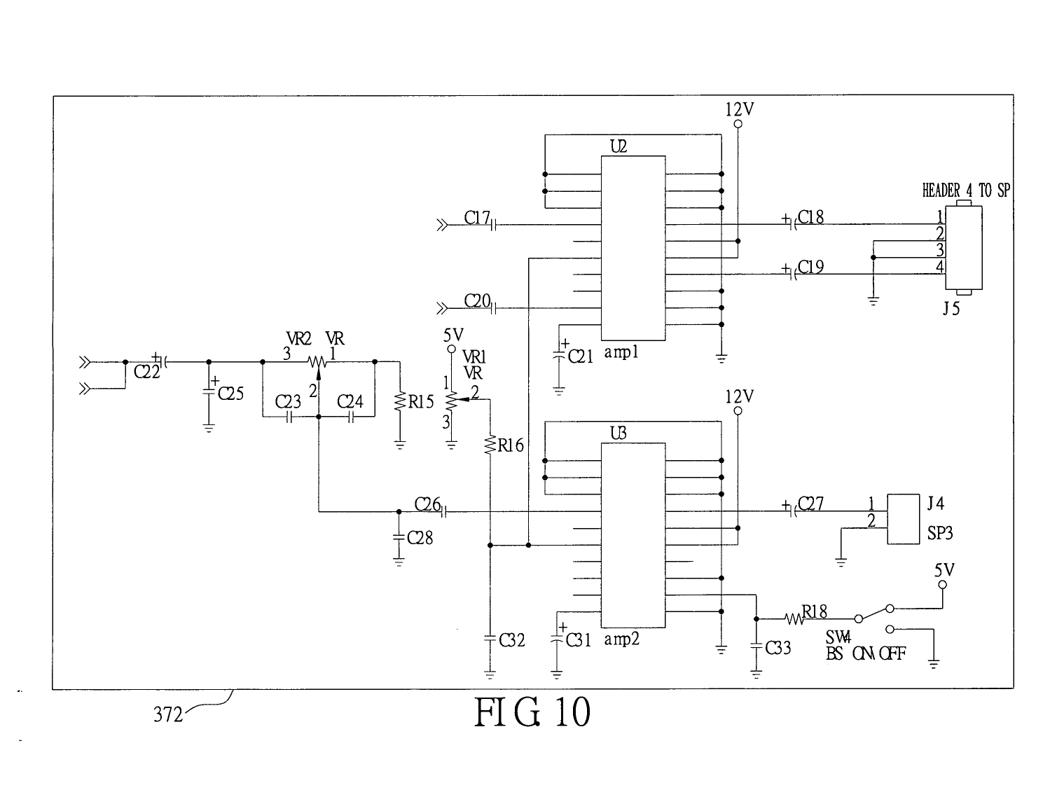

The first amplifier 31a and the second amplifier 31b connect with the body 38 of the portable audio system 30. The input/output interface unit 33 is located on a side surface of the body 38 and the input/output interface unit 33 is a USB interface. The circuit integration unit 37 is a circuit board and is located in an inner part of the body 38. The circuit integration unit 37 includes an interface control unit 371, an amplifying circuit unit 372 and an equalizing circuit unit 373. The interface control unit 371 is a USB controller and electrically connects with the input/output interface unit 33 for controlling the signal outputted from the input/output interface unit 33. The amplifying circuit unit 372 electrically connects with the interface control unit 371 for amplifying the audio signal. The equalizing circuit unit 373 electrically connects with the amplifying circuit unit 372 for improving the frequency response of the audio signal. It can separate mediant and treble, and provides high quality sound while on using a small amount of power. FIG. 9 shows the circuit diagram of the equalizing circuit unit. FIG. 10 shows the circuit diagram of the amplifying circuit unit.

In order to provide more functions, the portable audio system further includes other units. For representing sounds and audio effects via lights, a plurality of lighting units 34 (such as LEDs) are electrically connected with the circuit integration unit 37 and installed on a side surface of the body 38. For reducing the temperature of the portable audio system 30, a heat sink module 32 with a fan is installed in the inner section of the body 38. For adjusting the volume of the sound or audio effects, an audio effect tuning device 35 (such as a knob or a key) is electrically connected with the circuit integration unit 37 and installed on a side surface of the body 38.

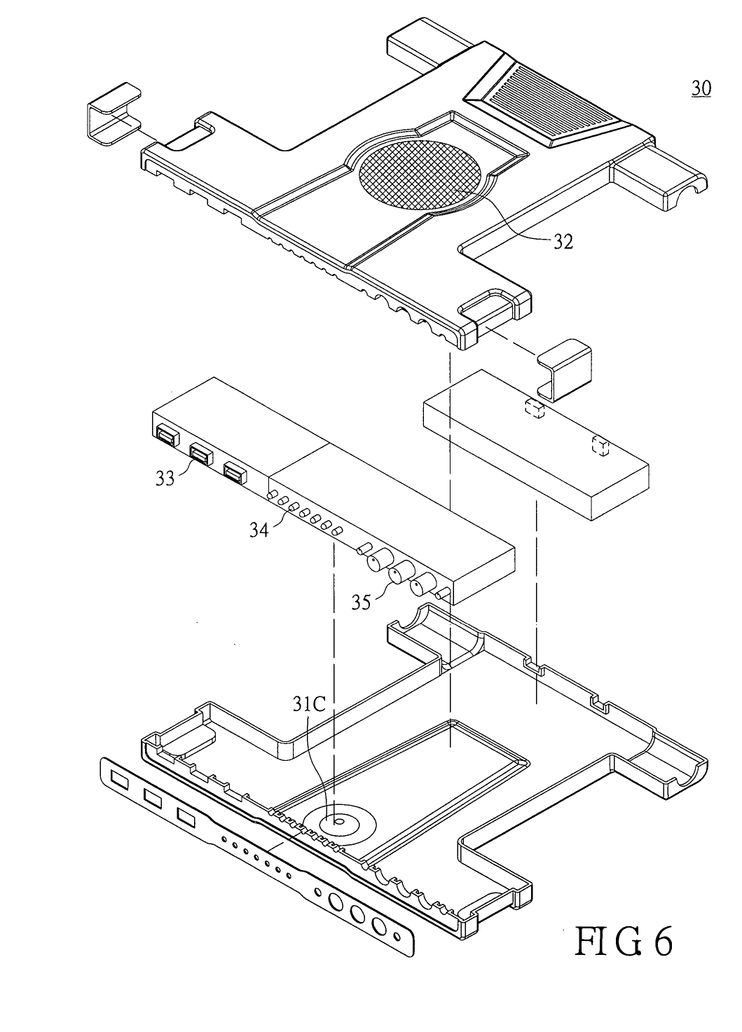

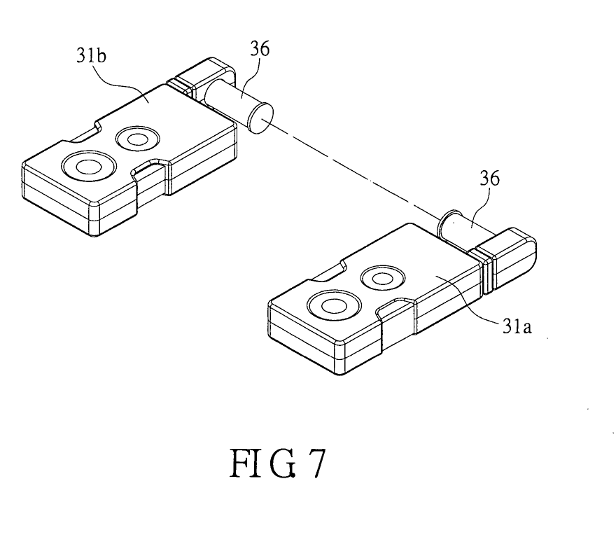

Please refer to FIG. 6 and FIG. 7. The first amplifier 31a and the second amplifier 31b are each individually installed on a side surface of the body 30, and a third amplifier 31c is located on the bottom of the body 38. The first amplifier 31a, the second amplifier 31b and the third amplifier 31c electrically connect with the circuit integration unit 37. The first amplifier 31a and the second amplifier 31b individually connect with the body 38 via a rotor. The rotor is a cylinder bearing. As such, the first amplifier 31a and the second amplifier 31b can be rotated to any angle. Due to the design of the body's structure 38, a portable electronic device (such as laptop) can be installed on the body 38 so that it does not influence the rotation of the first amplifier 31a or the second amplifier 31b. By using the above method, the angle and the location of the first amplifier 31a and the second amplifier 31b are not to be limited.

The first amplifier 31a and the second amplifier 31b are media amplifiers and can also be rotated to any angle. The third amplifier 31c is a bass amplifier. Thereby it provides 2.1-channel sound. The sound hoods of the first amplifier 31a, the second amplifier 31b and/or the third amplifier 31c are anti-magnetic sound hoods.

Moreover, the portable audio system 30 can have a built-in storage device (such as hard disk) for storing audio data. A display device can be installed in the body 38 for displaying the status of the portable audio system 30. The portable audio system 30 further includes a plurality of processing units for processing audio data of different formats, such as MP3, MIDI or WMV.

The present invention integrates an amplifier with a speaker into the portable audio system 30. Due to the design of the portable audio system, a portable electronic device can be installed on the portable audio system 30. Thereby, the portable audio system 30 integrates the portable electronic device into a single unit. The portable audio system 30 is a standalone apparatus and can be operated via a portable electronic device (such as a laptop, a PDA or an MP3 player) to provide a versatile audio effect.

The present invention has the following characteristics:

1. The present invention integrates speakers with an amplifier into the portable audio system and provides a high-quality sound using a low amount of power via an equalizer.

2. The amplifier can be rotated to any angle to provide multi-channel and surrounding sound effects.

3. The heat sink module lowers the temperature of the portable audio system and the portable electronic device.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable audio system, comprising:
a body;
at least one amplifier unit, connecting with the body;
at least one input/output interface unit, located on a side surface of the body;
a circuit integration unit, located in an inner part of the body;
wherein the circuit integration unit comprises:
an interface control unit, electrically connecting with the input/output interface unit for controlling the signal from the input/output interface unit
an amplifying circuit unit, electrically connecting with the interface control unit and the amplifier unit for amplifying the audio signal.

2. The portable audio system as claimed in claim 1, wherein the amplifier units individually connect with the body via a rotor so that the amplifier units can rotate in any angle.

3. The portable audio system as claimed in claim 2, wherein the design of the body's structure allows for a portable electronic device to be installed on the body and the portable electronic device doesn't affect the rotation of the amplifier units.

4. The portable audio system as claimed in claim 1, wherein the design of the body's structure allows for a portable electronic device to be installed on the body.

5. The portable audio system as claimed in claim 1, wherein the amplifier units comprises:
a first amplifier and a second amplifier, individually located on a side surface of the body;
a third amplifier, located on a bottom of the body.

6. The portable audio system as claimed in claim 5, wherein the first amplifier and the second amplifier are media amplifiers.

7. The portable audio system as claimed in claim 5, wherein the third amplifier is a bass amplifier.

8. The portable audio system as claimed in claim 1, wherein the sound hoods of the amplifiers are anti-magnetic sound hoods.

9. The portable audio system as claimed in claim 1, further comprising an equalizing circuit unit for improving the frequency response of the audio signal.

10. The portable audio system as claimed in claim 1, further comprising a plurality of lighting units, electrically connecting with the circuit integration unit and installed on a side surface of the body, for representing sounds or audio effects via lights.

11. The portable audio system as claimed in claim 1, further comprising a heat sink module, installed in the inner of the body, for reducing the temperature.

12. The portable audio system as claimed in claim 11, wherein the heat sink module includes a fan.

13. The portable audio system as claimed in claim 1, further comprising an audio effect tuning device, electrically connecting with the circuit integration unit and installed on a side surface of the body, for tuning the magnitude of the sound or audio effect.

14. The portable audio system as claimed in claim 1, further comprising a storage device for storing audio data.

15. The portable audio system as claimed in claim 1, further comprising a display device, installed in the body 38, for displaying the status of the portable audio system.

16. The portable audio system as claimed in claim 1, wherein the circuit integration unit is a circuit board.

17. The portable audio system as claimed in claim 1, wherein the input/output interface unit is a USB interface.

18. The portable audio system as claimed in claim 1, wherein the interface control unit is a USB controller.

19. The portable audio system as claimed in claim 1, further comprising a plurality of processing units for processing audio data of different formats.
